(19) United States
(12) Patent Application Publication
(10) Pub. No.: US 2010/0135432 A1
(43) Pub. Date: Jun. 3, 2010

(54) Wireless Transmission Apparatus, Wireless Reception Apparatus and Block Construction Method

(76) Inventors: Kenichi Miyoshi, Kanagawa (JP); Shinsuke Takaoka, Kanagawa (JP); Fumiyuki Adachi, Miyagi (JP); Hiromichi Tomeba, Miyagi (JP); Kazuki Takeda, Miyagi (JP)

Correspondence Address: Dickinson Wright PLLC;James E. Ledbetter, Esq., International Square, 1875 Eye Street, N.W., Suite 1200, Washington, DC, 20006, US

(21) Appl. No.: 12/596,344

(22) PCT Filed: Apr. 18, 2008
(86) PCT No.: PCT/JP2008/001030

§ 371 Date: Oct. 16, 2009

(51) Int. Cl. H04L 27/00

(52) U.S. Cl. 375/295; 375/316

(57) ABSTRACT

A wireless transmission apparatus in which degradation of error-rate characteristics can be avoided without decreasing a data rate in the mobile communication using a pre-coding together with a FDE. In this apparatus, a modulation unit (102) modulates a first data among transmission data with a first modulation method and generates a first symbol string, a modulation unit (103) modulates a second data among the transmission data with a second modulation method whose modulation multi-level number is larger than that of the first modulation method and generates a second symbol string, and a reproduction unit (104) reproduces the second symbol string and obtains a plurality of second symbol strings. An arrangement unit (105) arranges the plurality of the second symbol strings to both sides of the first symbol string and a pre-coding unit (106) performs a pre-coding to each symbol string after arrangement.

### TECHNICAL FIELD

The present invention relates to a radio transmitting apparatus, radio receiving apparatus and block forming method.

### BACKGROUND ART

To realize data rates over 100 Mbps for the next generation mobile communication system, various studies regarding radio transmission schemes that are suitable for high speed packet transmission are going on. Because it is necessary to widen the bandwidth of the frequency band to be used to perform such high speed packet transmission, studies to use the bandwidth around 100 MHz are going on.

If such wideband transmission is performed in mobile communication, it is known that a communication channel becomes a frequency selective channel formed with a plurality of paths of varying delay times. Therefore, with wideband transmission in mobile communication, preceding symbols interfere with subsequent symbols, causing inter-symbol interference and deteriorating error rate performance. Further, in a frequency selective channel, channel transfer functions fluctuate in frequency bands and therefore the spectra of signals that propagate through such a channel and are received are distorted.

Equalization technique provides a technique for canceling the influence of ISI and improving error rate performance. Equalization technique includes frequency domain equalization (“FDE”) used in radio receiving apparatuses. FDE is directed to dividing a received block into quadrature frequency components by performing a fast Fourier transform (“FFT”), multiplying each frequency component by an equalization weight which is an approximation to the reciprocal of the channel transfer function, and then performing an inverse fast Fourier transform (“IFFT”) of each frequency component into a time domain signal. This FDE can compensate for distortion of the spectrum of a received block, so that ISI is reduced and error rate performance is improved.

Further, recently, studies to combine Tomlinson-Harashima Precoding (hereinafter, “THP”) with FDE as transmission equalization technique of precoding technique, are going on. That is, studies to perform THP of transmission blocks in a radio transmitting apparatus and perform FDE of received blocks in a radio receiving apparatus, are going on. THP refers to processing of sequentially subtracting interference components from transmission blocks based on channel information. This THP makes it possible to cancel in advance the interference components which are added to transmission blocks, reduce ISI and improve error rate performance. Meanwhile, in case where channel information is completely learned, transmission where ISI is suppressed completely is possible. For example, even in case where frequency selective fading deteriorates a received level of frequency components significantly, and interference components are not removed because the frequency components are not completely equalized by performing FDE, it is possible to prevent deterioration of error rate performance by combining THP with FDE to remove interference components in advance.

However, the combination of THP with FDE has characteristics of deteriorating error rate performance of symbols near the head of a received block subjected to FDE. To prevent this deterioration of error rate performance, a conventional radio transmitting apparatus inserts dummy symbols near the head of blocks of poor error rate performance (see, for example, Non-Patent Document 1).

Non-Patent Document 1: “Single-Carrier Transmission with Frequency-Domain Equalization Using Tomlinson-Harashima Precoding,” K. Takeda, H. Tomeba, F. Adachi, IEICE Technical Report, RCS2006-41, pp. 37-42, 2006-6

### DISCLOSURE OF INVENTION

### Problems to be Solved by the Invention

When a dummy symbol is inserted near the head of a block as in the above conventional technique, the data rate corresponding to the length of the dummy symbol decreases.

It is therefore an object of the present invention to provide a radio transmitting apparatus, radio receiving apparatus and block forming method for preventing deterioration of error rate performance without decreasing the data rate, in mobile communication where precoding is combined with FDE.

### Means for Solving the Problem

The radio transmitting apparatus according to the present invention employs a configuration which includes: a first modulating section that modulates first data in transmission data by a first modulation scheme to generate a first symbol sequence; a second modulating section that modulates second data in the transmission data by a second modulation scheme using a greater M-ary modulation value than an M-ary modulation value of the first modulation scheme, to generate a second symbol sequence; a repetition section that repeats the second symbol sequence to acquire a plurality of second symbol sequences; an arranging section that arranges the plurality of second symbol sequences prior to and subsequent to the first symbol sequence; a precoding section that precodes each arranged symbol sequence; and a transmitting section that transmits each precoded symbol sequence.

### ADVANTAGEOUS EFFECTS OF INVENTION

The present invention makes it possible to prevent deterioration of error rate performance without decreasing the data rate, in mobile communication where precoding is combined with FDE.

### BRIEF DESCRIPTION OF DRAWINGS

FIG. 1 is a block diagram showing a configuration of a radio transmitting apparatus according to an embodiment of the present invention;

FIG. 2 is a block diagram showing a configuration of a radio receiving apparatus according to an embodiment of the present invention;

FIG. 3 shows mapping of each symbol by QPSK modulation;

FIG. 4 shows mapping of each symbol by 16 QAM modulation;

FIG. 5 shows error rate performance in single carrier transmission using THP and FDE; and

FIG. 6 shows an example of an arrangement of symbol sequences according to an embodiment of the present invention.

### BEST MODE FOR CARRYING OUT THE INVENTION

Hereinafter, an embodiment of the present invention will be explained in detail with reference to the accompanying drawings.

With the present embodiment, a radio transmitting apparatus transmits single carrier signals subjected to THP, to a radio receiving apparatus, and the radio receiving apparatus performs FDE of the single carrier signals.

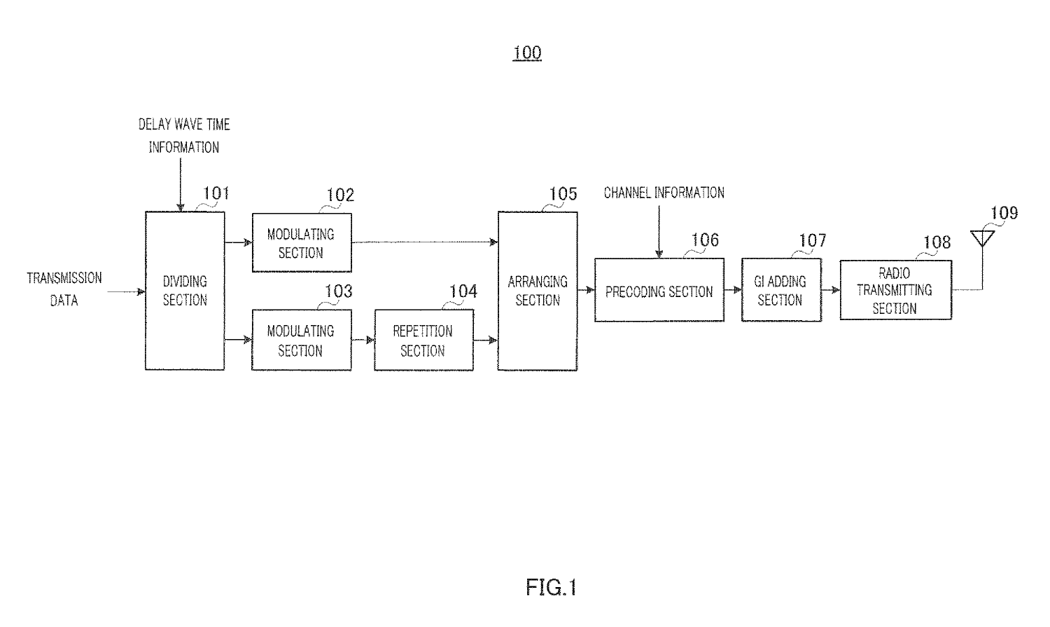

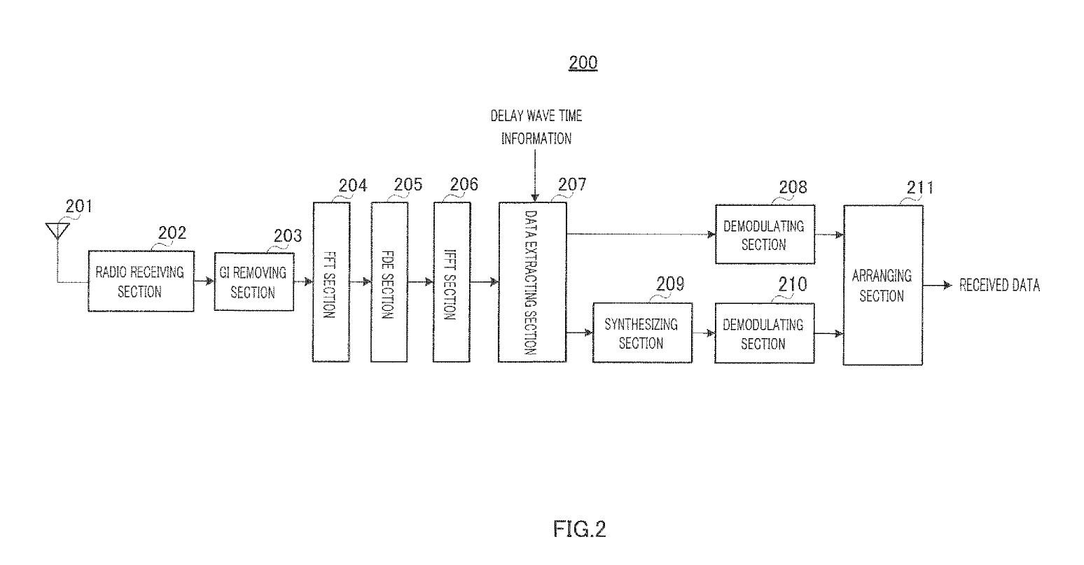

Hereinafter, the configurations of the radio transmitting apparatus and radio receiving apparatus according to the present embodiment will be explained. FIG. 1 shows the configuration of radio transmitting apparatus 100 according to the present embodiment, and FIG. 2 shows the configuration of radio receiving apparatus 200 according to the present embodiment.

In radio transmitting apparatus 100 shown in FIG. 1, dividing section 101 receives as input transmission data and delay wave time information from the receiving section (not shown).

Here, the delay wave time information is fed back from radio receiving apparatus 200 (FIG. 2). Then, dividing section 101 divides transmission data into the first data and second data, based on the inputted delay wave time information. Here, the data length of the second data is determined based on the delay wave time information. Further, the data length of the first data refers to the data length of transmission data that is left after the second data is removed. For example, dividing section 101 divides the first portion of transmission data as the second data and the second portion as the first data. Then, dividing section 101 outputs the first data to modulating section 102 and the second data to modulating section 103.

Modulating section 102 modulates the first data received as input from dividing section 101 by the first modulation scheme, to generate the first symbol sequence formed with a plurality of symbols. Then, modulating section 102 outputs the first symbol sequence to arranging section 105.

Modulating section 103 modulates the second data received as input from dividing section 101 by a second modulation scheme using a greater M-ary modulation value than the M-ary modulation value of the first modulation scheme, to generate a second symbol sequence formed with a plurality of symbols. Then, modulating section 103 outputs the second symbol sequence to repetition section 104.

Repetition section 104 repeats the second symbol sequence received as input from modulating section 103 (i.e. repetition), to acquire a plurality of second symbol sequences. Here, the number of second symbol sequences acquired in repetition section 104 is determined based on the difference between the M-ary modulation value of the first modulation scheme and the Mary modulation value of the second modulation scheme. To be more specific, the number of second symbol sequences is determined based on log₂n/log₂m. Here, m represents the M-ary modulation value of the first modulation scheme, and n represents the M-ary modulation value of the second modulation scheme. Then, repetition section 104 outputs a plurality of acquired second symbol sequences, to arranging section 105.

Arranging section 105 arranges the symbols of the first symbol sequence, received as input from modulating section 102, consecutively in the time domain, and arranges the symbols of a plurality of second symbol sequences, received as input from repetition section 104, consecutively prior to and subsequent to the arranged first symbol sequence. At this time, arranging section 105 places the halves of a plurality of symbols forming a plurality of second symbol sequences, in a symmetric arrangement prior to and subsequent to the first symbol sequence, respectively. In this way, a block is formed in which the first symbol sequence is arranged in the center portion and in which a plurality of same second symbol sequences are arranged prior to and subsequent to the first symbol sequence. Then, arranging section 105 outputs the block of a time domain signal, to precoding section 106.

From a receiving section (not shown), precoding section 106 receives channel information which shows the transmission characteristics of the channel and which is fed back from radio receiving apparatus 200. Using THP, precoding section 106 precedes the block received as input from arranging section 105. THP for a block formed with N_{c} symbols is implemented by a feedback filter of maximum N_{c} taps and a Modulo operation circuit. Further, the number of symbols N_{c} forming one block is the same as the number of symbols subjected to FDE in radio receiving apparatus 200. To be more specific, in THP, when an input block s=[s(N_{c}−1) . . . s(0)]^{T} of a block length N_{c} formed with symbols s(t)(t=0 to N_{c}−1) is received as input, the output block x=[x(N_{c}−1) . . . x(0)]^{T} is determined by following equation 1.

[1]

x=s−Fx+2Mz (Equation 1)

Here, the matrix F is the filter coefficient matrix at the time each symbol is received as input, and can be represented by following equation 2.

$$\begin{matrix}[ 2 ] & \\ F = [ \begin{matrix}0 & {f}_{0 , 1} & … & {f}_{0 , {N}_{C} - 1} \\ & ⋱ & ⋱ & ⋮ \\ & & ⋱ & {f}_{{N}_{C} - 2 , {N}_{C} - 1} \\ 0 & & & 0\end{matrix} ] & ( Equation 2 )\end{matrix}$$

f_{t,t+τ} refers to the τ-th feedback coefficient at the time the symbol s(t) is received as input. Feedback coefficients use the impulse response of a channel other than desired wave components in channel information received as input in precoding section 106. Further, zₜ=[zₜ(N_{c}−1) . . . zₜ(0)]^{T} is an equivalent representation of a Modulo operation. Modulo operation converts the real part and the imaginary part of a signal acquired in loop processing of a feedback filter, within the range of [−M, M] to stabilize outputs of THP. Further, in equation 1, the symbol s(t) satisfies −M≦{Re[s(t)],Im[s(t)]}<M. Then, precoding section 106 outputs the block subjected to THP, to GI (Guard Interval) adding section 107.

GI adding section 107 adds the rear portion of the block, as a GI, to the head of the block received as input from precoding section 106. Meanwhile, the signal formed with the block and the GI added to the head of the block, may be referred to as “slot.”

Radio transmitting section 108 performs radio transmission processing such as D/A conversion, amplification and up-conversion with respect to the block to which the GI is added, and transmits the signal from antenna 109 to radio receiving section 200 (FIG. 2). That is, radio transmitting section 108 transmits a single carrier signal to which the GI is added, to radio receiving apparatus 200.

Radio receiving apparatus 200 shown in FIG. 2 receives the single carrier signal transmitted from radio transmitting apparatus 100, that is, a time domain signal formed with the first symbol sequence and a plurality of second symbol sequences arranged prior to and subsequent to the first symbol sequence, through antenna 201, and performs radio receiving processing such as down-conversion and A/D conversion with respect to this single carrier signal.

GI removing section 203 removes the GI from the single carrier signal after radio receiving processing, and outputs the signal from which the GI has been removed, to FFT section 204.

FFT section 204 performs an FFT of a signal received as input from GI removing section 203, on a per block basis, to transform the block, which is a time domain signal, into a frequency domain signal. To be more specific, FFT section 204 performs an N_{c}-point FFT of a block of a block length N_{c} transmitted from radio transmitting apparatus 100 (FIG. 1) to divide the block of a block length N_{c} into N_{c} frequency components R(k) (k=0 to N_{c}−1). Then, FFT section 204 outputs the frequency components R(k) (k=0 to N_{c}−1), to FDE section 205.

FDE section 205 performs FDE of the frequency domain signal received as input from FFT section 204, that is, the frequency components R(k) (k=0 to N_{c}−1). To be more specific, FDE section 205 multiplies each frequency component by an equalization weight w(k) (k=0 to N_{c}−1). That is, FDE is equivalent to linear filter processing that uses w(k) (k=0˜N_{c}−1) as the transfer function. Then, FDE section 205 outputs the frequency components subjected to FDE, to IFFT section 206.

IFFT section 206 performs an IFFT of the frequency components received as input from FDE section 205, on a per block basis, to transforms the frequency components into a block, which is a time domain signal. To be more specific, IFFT section 206 performs an N_{c}-point IFFT of N_{c} frequency components, to transform the N_{c} frequency components into a block, which is a time domain signal formed with N_{c} symbols. IFFT section 206 outputs the block subjected to the IFFT, to data extracting section 207.

Data extracting section 207 receives as input delay wave time information, from the measuring section (not shown). Based on the delay wave time information, data extracting section 207 extracts the first symbol sequence and a plurality of second symbol sequences arranged prior to and subsequent to the first symbol sequence, from the block received as input from IFFT section 206. Then, data extracting section 207 outputs the first symbol sequence to demodulating section 208 and outputs a plurality of second symbol sequences to synthesizing section 209.

Demodulating section 208 demodulates the first symbol sequence received as input from data extracting section 207, by the same modulation scheme as the first modulation scheme used in modulating section 102 of radio transmitting apparatus 100 (FIG. 1), to generate the first data. Then, demodulating section 208 outputs the first data to arranging section 211.

Synthesizing section 209 synthesizes a plurality of second symbol sequences received as input from data extracting section 207 to generate a synthesized symbol sequence. Then, synthesizing section 209 outputs the synthesized symbol sequence to demodulating section 210.

Demodulating section 210 demodulates the synthesized symbol sequence received as input from synthesizing section 209, by the same modulation scheme as the second modulation scheme used in modulating section 103 of radio transmitting apparatus 100 (FIG. 1), to acquire synthesized data. Then, demodulating section 210 outputs the synthesized data to arranging section 211.

Arranging section 211 arranges the first data received as input from demodulating section 208 and the synthesized data received as input from demodulating section 210, consecutively in the time domain. For example, arranging section 211 arranges the first data in the time domain and arranges the synthesized data prior to this first data. By this means, it is possible to obtain received data equivalent to transmission data from radio transmitting apparatus 100 (FIG. 1), that is, received data in which the second data is arranged in the first portion of the block and in which the first data is arranged in the second portion.

Next, the operation of radio transmitting apparatus 100 having the above configuration will be explained in detail.

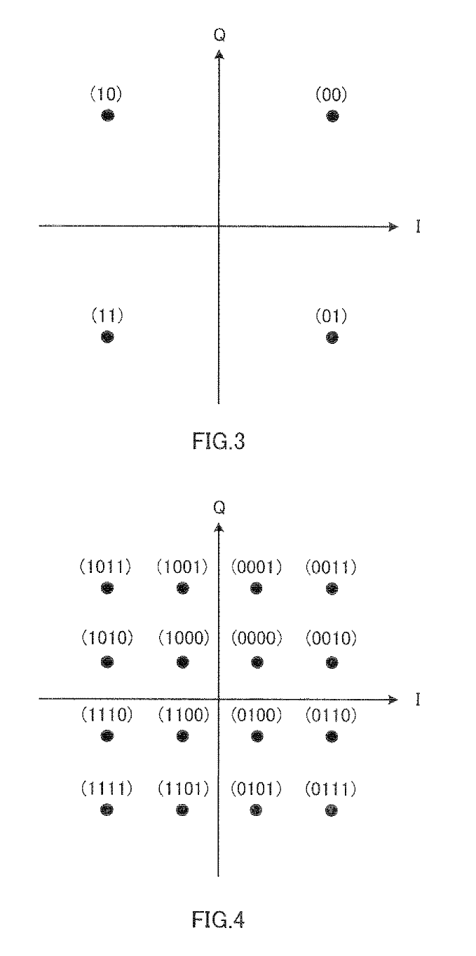

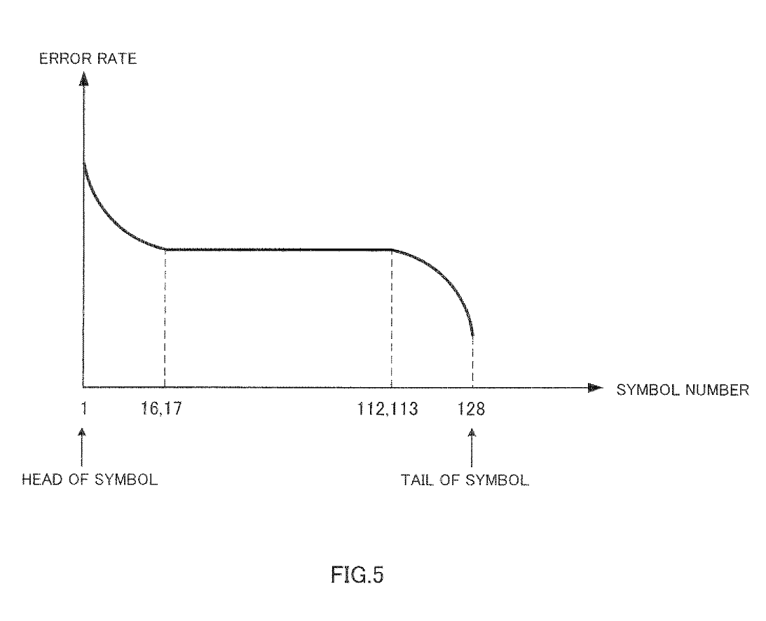

FIG. 3 shows mapping of each symbol by QPSK modulation. Further, FIG. 4 shows mapping of each symbol by 16 QAM modulation. As shown in FIG. 3, there are 4 mapping points with QPSK (that is, the M-ary modulation value is 4) and so 2 bits can be included and transmitted in one symbol. By contrast with this, as shown in FIG. 4, there are 16 mapping points with 16 QAM (that is, the M-ary modulation value is 16) and so 4 bits can be included and transmitted in one symbol. Consequently, the number of bits that can be included and transmitted in one symbol becomes double in case of the 16 QAM modulation scheme compared to the case of the QPSK modulation scheme. That is, by increasing the M-ary modulation value, it is possible to increase the number of bits that can be transmitted in one symbol. In other words, the number of symbols required to transmit the same number of bits of data becomes half in case of the 16 QAM modulation scheme compared to the QPSK modulation scheme. That is, by increasing the M-ary modulation value, it is possible to reduce the number of symbols required to transmit the same number of bits of data.

For example, while 64 bits of data is transmitted in 32 symbols by QPSK, in 16 QAM, 64 bits of data can be transmitted in 16 symbols, which is half of 32 symbols. That is, by modulating 64 bits of data by 16 QAM using a greater M-ary modulation value than the M-ary modulation value of QPSK, a margin for 16 symbols is secured in the time domain. Here, when the repeated, identical 16 symbols are transmitted using the time domain for the margin of symbols, even if the modulation scheme is 16 QAM, it is possible to transmit 64 bits of data, having the same data length as in the QPSK modulation scheme, in 32 symbols which is the same number of symbols as in the QPSK modulation scheme, and provide a diversity effect from repetition.

Then, with the present embodiment, the second data is modulated by the second modulation scheme using a greater M-ary modulation value than the M-ary modulation value of the first modulation value. By this means, it is possible to transmit a plurality of second symbol sequences including the same information as the symbol sequence modulated by the first modulation scheme, in the same number of symbols as in the case where modulation is performed by the first modulation scheme, so that it is possible to provide a diversity effect without decreasing the data rate.

Next, FIG. 5 shows an example of error rate performance in one block subjected to FDE, in case where THP is combined with FDE in single carrier transmission. Further, FIG. 5 shows error rate performance in case where the number of channel paths is sixteen. As shown in FIG. 5, error rate performance varies between symbols in one block. To be more specific, compared to the error rate performance of the symbols (corresponding to symbol numbers 17 to 112) in the center portion of the block, the error rate performance of the symbols (corresponding to symbol numbers 1 to 16) near the head of the block is deteriorated. By contrast with this, compared to the error rate performance of the symbols (corresponding to symbol numbers 17 to 112) in the center portion of the block, the error rate performance of the symbols (corresponding to symbol numbers 113 to 128) near the tail of the block is improved. Here, the number of symbols having deteriorating and improving error rate performances near the head and the tail of the block shown in FIG. 5, is determined depending on the number of channel paths. That is, here, the number of channel paths is sixteen, and, consequently, as shown in FIG. 5, the error rate performance of the 16 symbols (corresponding to symbol numbers 1 to 16) from the head of the block deteriorates and the error rate performance of the 16 symbols (corresponding to symbol numbers 113 to 128) from the tail of the block improves. Further, when the number of paths is greater, the portion in which error rate performance deteriorates and the portion in which error rate performance improves in one block become longer. Furthermore, this number of channel paths is inputted as delay wave time information in dividing section 101 of radio transmitting apparatus 100 (FIG. 1) and data extracting section 207 of radio receiving apparatus 200 (FIG. 2).

With the present embodiment, when a plurality of second symbol sequences are arranged in a block, a plurality of second symbol sequences are arranged near the head of the block and near the tail of the block. By this means, although the error rate performance of the second symbol sequences arranged near the head of the block becomes poorer, the error rate performance of the second symbol sequences arranged near the tail of the block becomes better, so that it is possible to prevent deterioration of the error rate performance of the second symbol sequences thanks to the diversity effect. Further, as shown in FIG. 5, while the error rate performance deteriorates gradually from symbol number 16 to symbol number 1, the error rate performance improves gradually from symbol number 113 to symbol number 128. Accordingly, when a plurality of second symbol sequences are arranged in a block, a plurality of symbols forming a plurality of second symbol sequences are placed in a symmetric arrangement in both the head and the tail portions of the block. By this means, the degree of deterioration of error rate performance and the degree of improvement of error rate performance are equal between the corresponding, identical symbols of a plurality of second symbol sequences arranged near the head of the block and near the tail of the block. Consequently, it is possible to realize a uniform diversity effect in all symbols forming the second symbol sequences.

Then, arranging section 105 places a plurality of symbols forming a plurality of second symbol sequences, in a symmetric arrangement prior to and subsequent to the first symbol sequence. That is, in one block, arranging section 105 arranges the first symbol sequence in the center portion of the block, and places the halves of a plurality of symbols forming a plurality of second symbol sequences, in a symmetric arrangement in the head and the tail portions of the block. In other words, in one block, arranging section 105 arranges the first symbol sequence in a portion in which error rate performance is maintained constant, and places the halves of a plurality of symbols forming a plurality of second symbol sequences, in a symmetric arrangement in a portion in which error rate performance gradually deteriorates compared to the portion of the constant error rate performance and in a portion in which error rate performance improves compared to the portion of the constant error rate performance, respectively.

The details will be explained below. Here, 256 bits of transmission data and 128 symbols of one block are assumed. Further, the first modulation scheme is QPSK (the M-ary modulation value m is 4) and the second modulation scheme is 16 QAM (the M-ary modulation value n is 16). Then, repetition section 104 acquires two second symbol sequences based on log₂n/log₂m. Further, as shown in FIG. 5, 16 symbols of a plurality of second symbol sequences are arranged from the head of the block (corresponding to symbol numbers 1 to 16) and from the tail of the block (corresponding to symbol numbers 113 to 128), respectively. Therefore, the first symbol sequence is arranged in the rest of 96 symbols (corresponding to symbol numbers 17 to 112).

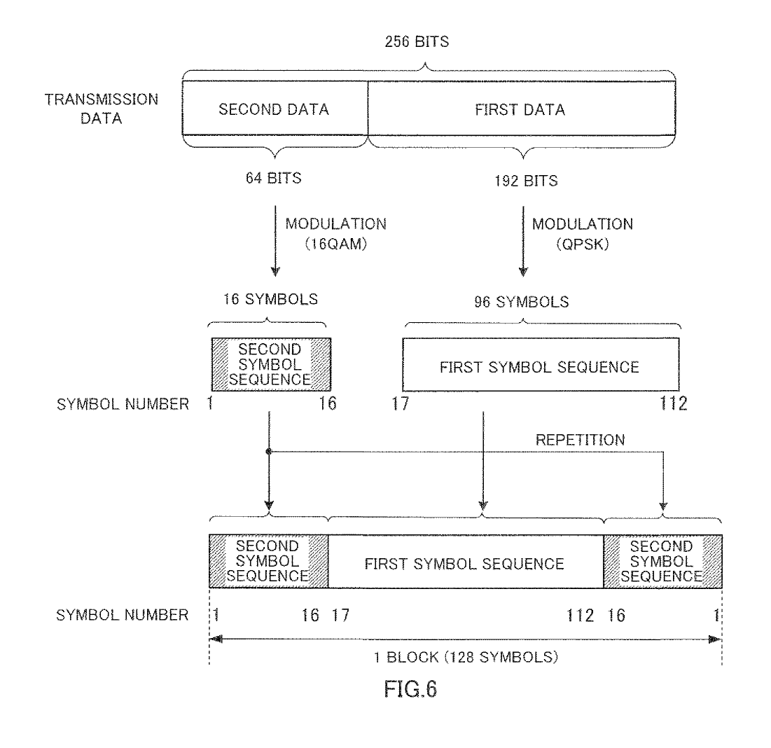

First, dividing section 101 divides transmission data of 256 bits into the first data and second data. To be more specific, as shown in FIG. 5, the number of symbols arranged at the head and tail portions of the block is 32 symbols and the M-ary modulation value of the first modulation scheme is 4 (two bits per symbol), and, consequently, dividing section 101 determines the data length of the second data as 64 bits (32 symbols×2 bits) as shown in FIG. 6. Further, dividing section 101 determines the data length of the first data in transmission data as 192 bits, not including the second data.

Next, modulating section 102 modulates 192 bits of the first data by QPSK as shown in FIG. 6, to generate 96 symbols of the first symbol sequence (corresponding to symbol numbers 17 to 112).

By contrast with this, modulating section 103 modulates 64 bits of the second data by 16 QAM as shown in FIG. 6, to generate the 16 symbols of the second symbol sequence (corresponding to symbol numbers 1 to 16). Further, repetition section 104 repeats the second symbol sequence of 16 symbols (corresponding to symbol numbers 1 to 16) to acquire two second symbol sequences.

Next, arranging section 105 rearranges the order of symbols in one of the second symbol sequence arranged prior to the first symbol sequence and the second symbol sequence arranged subsequent to the first symbol sequence, and then arranges the second symbol sequences prior to and subsequent to the first symbol sequence. By this means, the error rate performance of the second symbol sequence arranged subsequent to the first symbol sequence becomes better than the error rate performance of the second symbol sequence arranged prior to the first symbol sequence.

To be more specific, as shown in FIG. 6, arranging section 105 arranges one second symbol sequence (corresponding to symbol numbers 1 to 16) in the original symbol order, prior to the first symbol sequence (corresponding to symbols numbers 17 to 112), and arranges the other second symbol sequence (corresponding to symbol numbers 16 to 1) in which the order of symbols is rearranged, subsequent to the first symbol sequences (corresponding to symbol numbers 17 to 112). In other word, arranging section 105 arranges the first symbol sequence (corresponding to symbol numbers 17 to 112 shown in FIG. 6) in the center portion of a block (corresponding to symbol numbers 17 to 112 shown in FIG. 5) in which error rate performance is maintained constant, arranges one second symbol sequence (corresponding to symbol numbers 1 to 16 shown in FIG. 6) in the head portion (corresponding to symbol numbers 1 to 16 shown in FIG. 5) in which error rate performance is poorer than in the portion the constant error rate performance, and arranges the other second symbol sequence (corresponding to symbol numbers 16 to 1 shown in FIG. 6) in which the order of symbols is rearranged, in the tail portion (corresponding to symbol numbers 113 to 128 shown in FIG. 5) of the block in which error rate performance is better than in the portion of the constant error rate performance. By this means, even if the second symbol sequence is arranged in the head portion of a block in which error rate performance is poor, the identical second symbol sequence is arranged in the tail portion of the block in which error rate performance is good, so that it is possible to maintain good error rate performance of the second symbol sequence.

Synthesizing section 209 of radio receiving apparatus 200 (FIG. 2) synthesizes two second symbol sequences arranged prior to and subsequent to the first symbol sequence in the block shown in FIG. 6. At this time. synthesizing section 209 performs synthesis by rearranging the second symbol sequence (corresponding to symbol numbers 16 to 1 shown in FIG. 6) arranged in the tail portion of the block (corresponding to symbol numbers 113 to 128 shown in FIG. 5) back to the original order of symbols (in the order from symbol numbers 1 to 16). By this means, although the error rate performance of one second symbol sequence arranged prior to the first symbol sequence deteriorates as shown in FIG. 6, the error rate performance of the other second symbol sequence arranged subsequent to the first symbol sequence is good, so that synthesizing section 209 can acquire synthesized symbol sequence of 16 symbols having good error rate performance thanks to a diversity effect.

In this way, with the present embodiment, the radio transmitting apparatus arranges a plurality of second symbol sequences prior to and subsequent to the first symbol sequence. Then, the radio receiving apparatus synthesizes the second symbol sequence arranged in a portion of a received block in which error rate performance is poor and the second symbol sequence arranged in a portion in which error rate performance is good. By this means, the radio receiving apparatus can prevent deterioration of error rate performance of the second symbol sequence in a reliable manner.

Further, according to the present embodiment, the second data is modulated by the second modulation scheme using a greater M-ary modulation value than the Mary modulation value of the first modulation scheme, so that it is possible to transmit the second data in a small number of symbols compared to the first modulation scheme. By this means, even in case where the same number of symbols of a plurality of second symbol sequences as in the case where modulation is performed by the first modulation scheme, are arranged, it is possible to transmit all transmission data. Consequently, it is possible to prevent deterioration of error rate performance without decreasing the data rate, in mobile communication where precoding is combined with FDE.

An embodiment of the present invention has been described so far.

Further, the radio transmitting apparatus and radio receiving apparatus according to the present invention are suitable for use in radio communication mobile station apparatuses or radio communication base station apparatuses used in, for example, mobile communication systems. By mounting the radio transmitting apparatus and radio receiving apparatus according to the present invention on a radio communication mobile station apparatus or radio communication base station apparatus, it is possible to provide a radio communication mobile station apparatus and radio communication base station apparatus having the same function and operation as described above.

Further, with the above embodiment, precoding is performed using THP. However, the present invention is not limited to THP, and is also applicable to radio transmitting apparatus that performs precoding having characteristics of deteriorating the error rate performance of symbols near the head of a block compared to the error rate performance of symbols in the center of the block, and of improving the error rate performance of symbols near the tail of the block.

Further, with the above embodiment, as shown in FIG. 6, the first portion of transmission data is the second data and the second portion is the first data. However, with the present invention, the second data is not limited to the first portion of transmission data and may be an arbitrary portion of transmission data.

Further, a case has been described with the above embodiment where the number of a plurality of second symbol sequences acquired in repetition section 104 is determined based on the difference between the M-ary modulation value of the first modulation scheme and the M-ary modulation value of the second modulation scheme. However, with the present invention, the M-ary modulation value is correlated with the number of bits in one symbol, so that the number of second symbol sequences acquired in repetition section 104 may be determined based on the difference between the number of bits M in one symbol in case of the first modulation scheme and the number of bits N in one symbol in case of the second modulation scheme. To be more specific, the number of second symbol sequences is determined based on N/M.

Further, a case has been explained with the above embodiment where the M-ary modulation value of the first modulation scheme and the M-ary modulation value of the second modulation scheme are determined in advance and the number of second sequences acquired in repetition section 104 is determined based on the difference between the M-ary modulation values. However, with the present invention, it is possible to determine the M-ary modulation value m of the first modulation scheme and the number of second symbol sequences R in advance and determine the Mary modulation value of the second modulation scheme based on m^{R}. Further, it is possible to determine the number of bits in one symbol of the second modulation scheme based on the number of bits M in one symbol of the first modulation scheme and the number of the second symbol sequences R acquired in repetition section 104. To be more specific, the number of bits in one symbol in case of the second modulation scheme is determined based on MR.

Further, a case has been explained with the above embodiment where a plurality of second symbol sequences are acquired by repeating a second symbol sequence. However, with the present invention, it is also possible to acquire a plurality of second symbol sequences by modulating a plurality of items of second data, which are acquired by repeating the second data, by the second modulation scheme.

Further, with the above embodiment, the first modulation scheme is QPSK and the second modulation scheme is 16 QAM. However, with the present invention, the first modulation scheme is not limited to QPSK, and the second modulation scheme is not limited to 16 QAM. For example, the second modulation scheme may be 64 QAM or 256 QAM. In case where the second modulation scheme is 64 QAM, that is, in case where the M-ary modulation value is 64, it is possible to transmit triple transmission bits in the same number of symbols as in QPSK of the first modulation scheme (i.e. the Mary modulation value is 4). Accordingly, in case where the second modulation scheme is 64 QAM, a second symbol sequence is repeated for three second symbol sequences. Further, in case where the second modulation scheme is 256 QAM, that is, in case where the M-ary modulation value is 256, it is possible to transmit quadruple bits in the same number of symbols as in QPSK of the first modulation scheme. Accordingly, in case where the second modulation scheme is 256 QAM, the second symbol sequence is repeated for four second symbol sequences. Furthermore, the first modulation scheme may be BPSK and the second modulation scheme may be QPSK.

A case has been explained with the above embodiment where transmission data is divided into the first data and second data and a plurality of second symbol sequences are arranged prior to and subsequent to the first symbol sequence. However, the present invention is also applicable to cases where transmission data is divided into three or more items of data. For example, it is possible to divide transmission data into the first data, second data and third data, modulate the first, second and third data to the first symbol sequence, second symbol sequences and third symbol sequences, respectively, arrange a plurality of second symbol sequences prior to and subsequent to the first symbol sequence and arrange a plurality of third symbol sequences arranged prior to and subsequent to the sequence formed by the first symbol sequence and a plurality of second symbol sequences.

Also, although a case has been described with the above embodiment as an example where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-111360, filed on Apr. 20, 2007, including the specification, drawings and abstract, is incorporated herein by reference in its entirety.

### INDUSTRIAL APPLICABILITY

The present invention is applicable to, for example, a mobile communication system.

1. A radio transmitting apparatus comprising:
a first modulating section that modulates first data in transmission data by a first modulation scheme to generate a first symbol sequence;
a second modulating section that modulates second data in the transmission data by a second modulation scheme using a greater M-ary modulation value than an M-ary modulation value of the first modulation scheme, to generate a second symbol sequence;
a repetition section that repeats the second symbol sequence to acquire a plurality of second symbol sequences;
an arranging section that arranges the plurality of second symbol sequences prior to and subsequent to the first symbol sequence;
a precoding section that precodes each arranged symbol sequence; and
a transmitting section that transmits each precoded symbol sequence.

2. The radio transmitting apparatus according to claim 1, wherein error rate performance of the second symbol sequence arranged subsequent to the first symbol sequence is better than error rate performance of the second symbol sequence arranged prior to the first symbol sequence.

3. The radio transmitting apparatus according to claim 1, wherein the arranging section places a plurality of symbols forming the plurality of second symbol sequences, in a symmetric arrangement prior to and subsequent to the first symbol sequence.

4. The radio transmitting apparatus according to claim 3, wherein the arranging section arranges halves of the plurality of symbols prior to and subsequent to the first symbol sequence, respectively.

5. The radio transmitting apparatus according to claim 1, wherein the arranging section rearranges an order of symbols in one of the second symbol sequence arranged prior to the first symbol sequence and the second symbol sequence arranged subsequent to the first symbol sequence, and then arranges the plurality of second symbol sequences prior to and subsequent to the first symbol sequence.

6. The radio transmitting apparatus according to claim 1, wherein the repetition section acquires log₂n/log₂m second symbol sequences, where m is the M-ary modulation value of the first modulation scheme and n is the M-ary modulation value of the second modulation scheme.

7. The radio transmitting apparatus according to claim 1, wherein the second modulating section modulates the second data by the second modulation scheme using an M-ary modulation value m^{R}, where m is the M-ary modulation value of the first modulation scheme and R is a number of the plurality of second symbol sequences.

8. The radio transmitting apparatus according to claim 1, further comprising a dividing section that divides transmission data into the first data and the second data based on delay wave time information.

9. The radio transmitting apparatus according to claim 8, wherein the dividing section determines a data length of the second data based on a number of symbols in the plurality of second symbol sequences and the M-ary modulation value of the first modulation scheme.

10. The radio transmitting apparatus according to claim 1, wherein the precoding section performs the precoding using a Tomlinson-Harashima Precoding method.

11. A radio receiving apparatus that uses frequency domain equalization, the radio receiving apparatus comprising:
a receiving section that receives a first symbol sequence and a plurality of second symbol sequences arranged prior to and subsequent to the first symbol sequence;
a synthesizing section that synthesizes the plurality of second symbol sequences to generate a synthesized symbol sequence;
a first demodulating section that demodulates the first symbol sequence by a first modulation scheme to generate first data; and
a second demodulating section that demodulates the synthesized symbol sequence by a second modulation scheme using a greater M-ary modulation value than an M-ary modulation value of the first modulation scheme, to generate synthesized data.

12. The radio transmitting apparatus according to claim 1 that comprises one of a radio communication base station apparatus and a radio communication mobile station apparatus.

13. The radio receiving apparatus according to claim 11 that comprises one of a radio communication base station apparatus and a radio communication mobile station apparatus.

14. A block forming method in a radio transmitting apparatus that performs precoding, the block forming method comprising:
forming a block in which a first symbol sequence that is acquired by modulating first data in transmission data by a first modulation scheme, is arranged in a center portion, and in which a plurality of identical second symbol sequences that are acquired by modulating second data in the transmission data by a second modulation scheme using a greater M-ary modulation value than an M-ary modulation value of the first modulation scheme, are arranged in a head portion and a tail portion.
